(19) United States
(12) Patent Application Publication
(10) Pub. No.: US 2017/0119111 A1
(43) Pub. Date: May 4, 2017

(54) METHOD AND COMPOSITION FOR CHANGING THE APPEARANCE OF TEETH

(71) Applicant: ADAM DOUDNEY, AUCKLAND (NZ)

(72) Inventor: ADAM DOUDNEY, AUCKLAND (NZ)

(21) Appl. No.: 14/928,716

(22) Filed: Oct. 30, 2015

(51) Int. Cl. A44C 15/00; A45D 34/04; A61C 13/15

(52) U.S. Cl. CPC A44C 15/007; A61C 19/003; A45D 34/04; A44C 15/0005

(57) ABSTRACT

A method for changing the appearance of a tooth by applying a composition to it. The composition has a cosmetic enhancer and also has a substantially transparent binder which binds the cosmetic enhancer to the tooth.

### FIELD OF INVENTION

The invention generally relates to a method and a composition for changing the appearance of teeth. More particularly but not exclusively the invention relates to a method for changing the appearance of teeth by using a composition having a transparent binder and a cosmetic enhancer.

### BACKGROUND

There is a growing demand for people to change their appearance so that they can stand out and look different. In some instances people have their teeth drilled down so that they can fit cosmetic enhancers such as diamonds etc into them. A problem with drilling teeth down is that it is permanent, it can be painful and there is the risk of seriously damaging the tooth.

It is an object of a preferred form of the present invention to go at least some way towards addressing the above problem. While this is an object of a preferred embodiment, it should not be seen as a limitation on the scope of the invention as claimed. The object of the invention per se is simply to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein; this reference does not constitute an admission that any of these documents form part of the common general knowledge in the art, in the United States of America or in any other country.

The term “comprising” and derivatives thereof, eg “comprises”, if and when used herein in relation to a combination of features should not be taken as excluding the possibility that the combination may have further unspecified features. For example, a statement that an arrangement “comprises” certain parts does not mean that it cannot also, optionally, have additional parts.

### SUMMARY OF THE INVENTION

According to one aspect of the invention there is provided a method of changing the appearance of a tooth, comprising the steps of:
applying to a tooth a substantially transparent binder; and
applying at least one cosmetic enhancer to the binder so that the cosmetic enhancer is bound to the tooth by the binder.

Preferably the binder is a dental grade composite resin.

Preferably the binder is light curing.

Preferably the binder is self curing.

Preferably the binder and cosmetic enhancer are applied simultaneously.

Preferably the binder and cosmetic enhancer are applied separately.

Preferably a resin bond is applied to the tooth prior to the binder and cosmetic enhancer and wherein the resin bond is light curing or self curing.

Preferably the cosmetic enhancer is glitter.

Preferably the cosmetic enhancer is a phosphorescent pigment.

Preferably the cosmetic enhancer is a true or artificial precious metal.

Preferably the cosmetic enhancer is a true or artificial precious stone.

Preferably the cosmetic enhancer is a letter, number, and/or a shape.

Preferably a stencil is used to produce a letter, number and/or shape on the tooth.

Preferably the cosmetic enhancer is an audio-visual device.

In another aspect of the invention there is provided a composition for changing the appearance of a tooth, having:
at least one cosmetic enhancer; and
a substantially transparent binder which can bind at least one cosmetic enhancer to a tooth.

Preferably the cosmetic enhancer comprises:
glitter; and/or
a phosphorescent pigment; and/or
a true or artificial precious metal; and/or
a true or artificial precious stone; and/or
a letter, number, and or a shape; and/or
an audio-visual device.

Preferably the binder is a dental grade composite resin and is either self curing or light curing.

In a further aspect of the invention there is provided a kit of parts for changing the appearance of a tooth comprising:
a substantially transparent binder; and
at least one cosmetic enhancer;

wherein each binder or enhancer is contained in a separate container.

Preferably the binder is a dental grade composite resin and is light curing or self curing.

Preferably the cosmetic enhancer is:
glitter; and/or
a phosphorescent pigment; and/or
a true or artificial precious metal; and/or
a true or artificial precious stone; and/or
a letter, number, and or a shape; and/or
an audio-visual device.

Preferably the kit also has:
a curing light; and/or
a resin bond which is either light or self curing; and/or
cotton rolls or buds; and/or
a stencil for applying a shape, number or letter;

wherein each curing light, resin bond, and/or cotton rolls and buds, or stencil are contained in separate containers.

These and other features, objects and advantages of the present invention will be readily apparent to persons of ordinary skill in the art upon reading the entirety of this disclosure, which includes the accompanying drawings and claims.

### BRIEF DESCRIPTION OF THE DRAWINGS

Some preferred embodiments of the invention will now be described by way of example and with reference to the accompanying drawings, of which:

FIG. 1 is a front view illustrating a first embodiment of a cosmetic enhancer applied to a tooth;

FIG. 2 is a plan view of three stencils which can be used to apply a cosmetic enhancer to a tooth in some embodiments; and

FIG. 3 is a front view of a cosmetic enhancer being applied to a tooth.

### DETAILED DESCRIPTION

Preferred forms of the invention will now be described by way of example although it should be appreciated that the inventive concept is not limited to these.

In a preferred embodiment the invention provides a method of changing the appearance of a tooth or teeth by applying a composition to them. In another embodiment the invention relates to a composition for changing the appearance of a tooth or teeth. References through the specification to a tooth or teeth relate to any type of natural teeth of a mammal or any type of artificial or false teeth. It will also be appreciated that references to a tooth or teeth through the specification relate to a tooth or teeth that have not been drilled into for the purpose of applying the composition.

The inventive composition comprises a cosmetic enhancer and a substantially transparent binder which binds the cosmetic enhancer to a tooth. References throughout the specification to a cosmetic enhancer relates to any colouring, particle, metal, stone, shape or letter etc which when applied to a tooth changes the visual appearance of it.

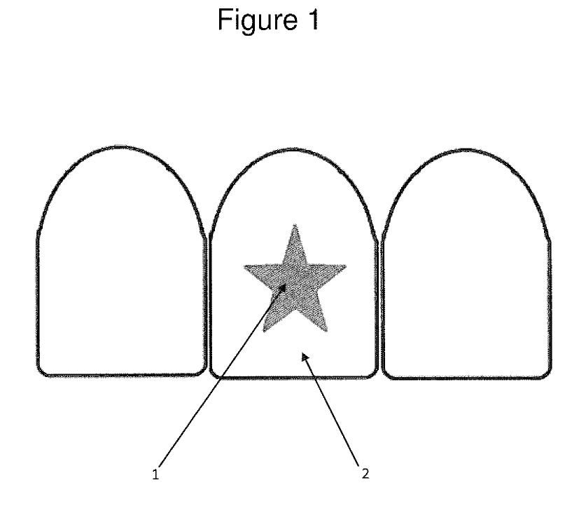

In a particularly preferred embodiment of the invention the cosmetic enhancer is glitter (e.g. small, flat reflective particles). In another embodiment the cosmetic enhancer is a phosphorescent pigment such as zinc sulphide and strontium aluminate. In a further embodiment of the invention the cosmetic enhancer is a true or artificial precious metal such as gold, silver and platinum. In another embodiment the cosmetic enhancer is a true or artificial precious stone such as a ruby or a diamond. In an alternative embodiment the cosmetic enhancer is a letter, a number or a shape e.g. a heart or a sphere etc. FIG. 1 shows a cosmetic enhancer in the shape of a star 1 which has been applied to a tooth 2. It will be appreciated by those skilled in the art that if the cosmetic enhancer is a letter, number of a shape that these can be made from any suitable material. In a further embodiment the cosmetic enhancer can consist of audio-visual technology or device for example a small LED or flat screen which can be used to present different images and sounds and in some embodiments the image can be adjusted with a remote control.

The binder which binds the cosmetic enhancer to the tooth is substantially transparent (e.g. clear). The binder is most preferably a dental grade composite resin. Dental grade composite resins are well known resins used in dentistry as adhesives. Composite resins are most commonly composed of Bis-GMA and other dimethacrylate monomers (TEGMA, UDMA, HDDMA), a filler material such as silica and in most current applications, a photoinitiator. In some embodiments the binder can be glass ionomer cement, a resin modified glass ionomer cement or porcelain containing restorative material. The transparent resin can also be filled with white filler so users can paint over dark teeth themselves to whiten darker teeth. It will also be appreciated that alternative dental adhesives can be used which are less toxic.

In a particularly preferred embodiment of the invention the binder is a transparent light curing (or light activated) dental grade composite resin. Those skilled in the art will know that there are a number of ways to cure light activated resin for example tungsten halogen and LED are types of lights which can be used. Specialised dental curing lights can also be used and these are well known in the art. In an alternative embodiment the binder is a transparent self-curing dental grade composite resin. It will be appreciated by those skilled in the art that the binder can be easily modified or tailored for example to allow for easier curing so that it makes it more sensitive to natural Light (broader wavelength spectrum) to enable hardening without the use of a specialist light.

In use if a long term bond is desired then the tooth or teeth of the user are cleaned (either by the user themselves or a dentist etc) and some light curing resin bond is wiped onto the tooth for 20-30 seconds. An example of a resin bond commonly used in dentistry is an etching bonding agent. This is then light cured for 10-20 seconds. The transparent binder is then applied to the tooth. In some embodiments the cosmetic enhancer (e.g. glitter) is premixed with the binder prior to applying it and in other embodiments the binder is applied first and then the enhancer (e.g. a letter or shape) is applied afterwards. Cotton rolls or buds can be used to assist with the placing of the enhancer. After the transparent binder and cosmetic enhancer have been applied the tooth is light cured for 20-30 seconds. In some embodiments a high strength light can be used to rapidly cure (e.g. about 3 seconds) the binder or bond. In some embodiments a sticker can be used to cover the teeth either side of the tooth to which the binder and cosmetic enhancer are being applied in order to prevent the binder or cosmetic enhancer being applied to the wrong tooth.

It will be appreciated that alternative processes can be used to apply the composition for example a tooth can be prepared by etching it with a low pH material such as phosphoric acid which is then cleaned off using water and then dried. After it is dried the composition (transparent binder and cosmetic enhancer) can be applied to the tooth. Alternatively instead of etching the tooth with a separate low pH material, a self-etching bond may be used, or the tooth can be roughened mechanically.

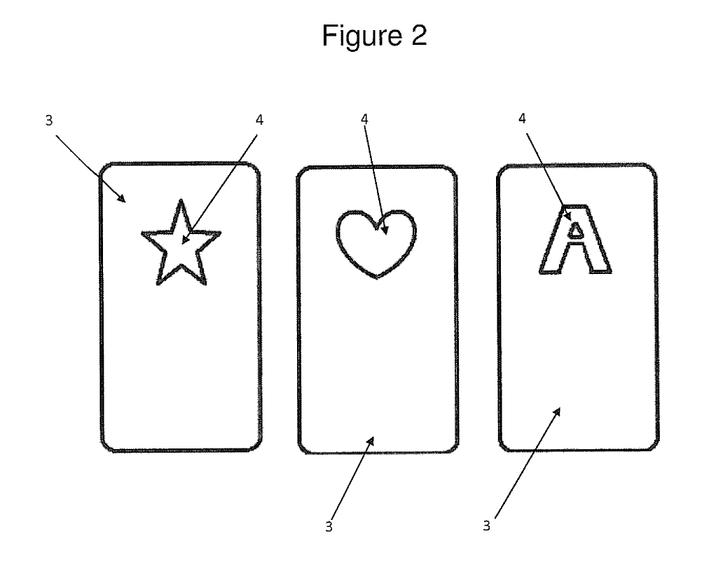

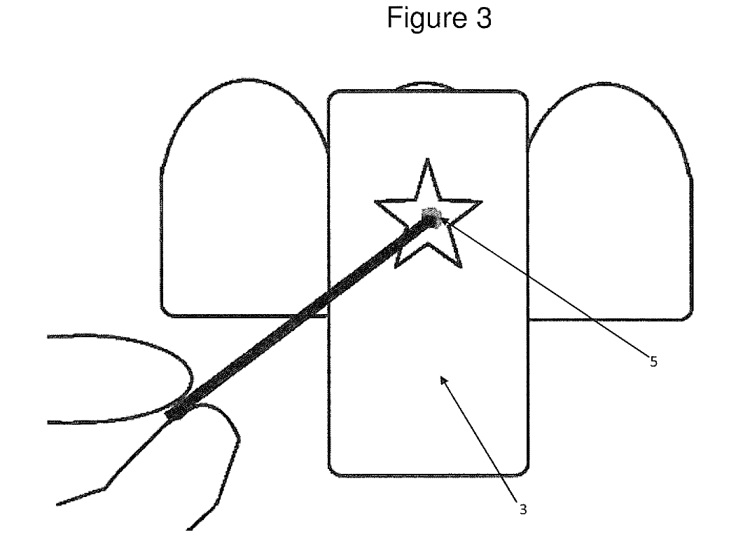

In some embodiments when the cosmetic enhancer is a letter, number or shape the cosmetic enhancer can be applied using a stencil. FIG. 2 illustrates three different stencils 3 with shapes 4 cut out of them. The back of the stencils 3 can have an adhesive on them so that it can be stuck to the surface of a tooth. Once the stencil 3 has been placed on the tooth the exposed part of the tooth has a binder and a cosmetic enhancer (e.g. glitter or a dye etc) 5 applied to it like shown in FIG. 3. After the cosmetic enhancer 5 has been cured the stencil 3 is removed. The stencil 3 also helps to prevent the cosmetic enhancer from being applied to parts of the tooth where it is not desired. Also in some embodiments the stencils can contain multiple shapes. In an alternative embodiment of the invention the shape, letter number etc can be pre shaped and is applied to the tooth with a binder.

If a temporary bond is desired then a user or dentist can add the binder and cosmetic enhancer to the tooth without using a resin bond. The invention can also use a self curing transparent binder instead of a light curing transparent binder to enable easier application. It will be appreciated by those skilled in the art that in some instances direct natural sunlight can be used to cure the transparent binder and/or bond. It will also be appreciated by those skilled in the art that the user or dentist can choose the desired thickness and size of transparent binder and cosmetic enhancer.

Apart from the safety benefits of not drilling a tooth down the composition and method also has a number of additional benefits/advantages for example it is cheap and cost effective. The method is also simple and easy to follow and the composition can be self applied by users or can be applied by dentists, dental assistants, beauticians etc. Also the composition when applied can be temporary whereas a drilled down tooth is permanent.

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example the particular elements of the cosmetic enhancer and the binder may vary dependent on the particular application for which it is used without variation in the spirit and scope of the present invention.

In addition, although the preferred embodiments described herein are directed to methods and a composition for changing the appearance of a tooth it will be appreciated by those skilled in the art that variations and modifications are possible within the scope of the appended claims.

1. A method of changing the appearance of a tooth, comprising the steps of:
applying to a tooth a substantially transparent binder; and
applying to the binder at least one cosmetic enhancer so that the cosmetic enhancer is bound to the tooth by the binder.

2. A method according to claim 1, wherein the binder is a dental grade composite resin.

3. A method according to claim 1, wherein the binder is light curing.

4. A method according to claim 1, wherein the binder is self curing.

5. A method according to claim 1, wherein the binder and cosmetic enhancer are applied simultaneously.

6. A method according to claim 1, wherein the binder and cosmetic enhancer are applied separately.

7. A method according to claim 1, wherein a resin bond is applied to the tooth prior to the binder and cosmetic enhancer and wherein the resin bond is light curing or self curing.

8. A method according to claim 1 wherein the cosmetic enhancer is glitter.

9. A method according to claim 1, wherein the cosmetic enhancer is a phosphorescent pigment.

10. A method according to claim 1, wherein the cosmetic enhancer is a true or artificial precious metal or a true or artificial precious stone.

11. A method according to claim 1, wherein the cosmetic enhancer is a letter, number, and/or a shape.

12. A method according to claim 1, wherein the cosmetic enhancer is a letter, number, and/or a shape and wherein a stencil is used to help produce the letter, number and/or shape on the tooth.

13. A method according to claim 1, wherein the cosmetic enhancer is an audio-visual device.

14. A composition changing the appearance of a tooth, having:
at least one cosmetic enhancer; and
a substantially transparent binder which can bind at least one cosmetic enhancer to a tooth.

15. A composition according to claim 14, wherein the cosmetic enhancer comprises:
glitter; and/or
a phosphorescent pigment; and/or
a true or artificial precious metal; and/or
a true or artificial precious stone; and/or
a letter, number, and or a shape; and/or
an audio-visual device.

16. A composition according to claim 14, wherein the binder is a dental grade composite resin and is either self curing or light curing.

17. A kit of parts for changing the appearance of a tooth comprising:
a substantially transparent binder; and
at least one cosmetic enhancer;
wherein each binder or cosmetic enhancer is contained in a separate container.

18. A kit of parts according to claim 17, wherein the binder is a dental grade composite resin and is light curing or self curing.

19. A kit of parts according to claim 17, wherein the cosmetic enhancer comprises:
glitter; and/or
a phosphorescent pigment; and/or
a true or artificial precious metal; and/or
a true or artificial precious stone; and/or
a letter, number, and/or a shape; and/or
an audio-visual device.

20. A kit of parts according to claim 17, wherein the kit also has:
a curing light; and/or
a resin bond which is either light curing or self curing; and/or
cotton rolls or buds; and/or
a stencil for applying a shape, number or letter;
wherein each curing light, resin bond, or cotton rolls or buds, or stencil are each contained in a separate container.
